(19) United States
(12) Patent Application Publication
(10) Pub. No.: US 2011/0061093 A1
(43) Pub. Date: Mar. 10, 2011

(54) TIME DEPENDENT ACCESS PERMISSIONS

(76) Inventors: Ohad KORKUS, Herzilia (IL); Yakov FAITELSON, Elkana (IL); Ophir KRETZER-KATZIR, Reut (IL); David BASS, Carmei Yoseph (IL)

(21) Appl. No.: 12/861,967

(22) Filed: Aug. 24, 2010

Related U.S. Application Data
(60) Provisional application No. 61/240,726, filed on Sep. 9, 2009.
(60) Provisional application No. 61/348,822, filed on May 27, 2010.

(51) Int. Cl. G06F 17/30

(52) U.S. Cl. 726/4

(57) ABSTRACT

A network object access permission management system useful with a computer network including at least one server and a multiplicity of clients, the system including an access permissions subsystem which governs access permissions of users to network objects in the computer network in real time and a future condition based permissions instruction subsystem providing instructions to the access permission subsystem to grant or revoke access permissions of the users to network objects in real time in response to future fulfillment of conditions which are established by an operator in advance.

### REFERENCE TO RELATED APPLICATIONS

Reference is made to U.S. Provisional Patent Application Ser. No. 61/240,726, filed Sep. 9, 2009 and entitled “USE OF ACCESS METRIC IN LARGE SCALE DATA MANIPULATION”, the disclosure of which is hereby incorporated by reference and priority of which is hereby claimed pursuant to 37 CFR 1.78(a) (4) and (5)(i).

Reference is also made to U.S. patent application Ser. No. 12/673,691, filed Jan. 27, 2010,and entitled “ENTERPRISE LEVEL DATA MANAGEMENT”, the disclosure of which is hereby incorporated by reference and priority of which is hereby claimed pursuant to 37 CFR 1.78(a) (1) and (2)(i).

Reference is also made to U.S. patent application Ser. No. 12/814,807, filed Jun. 14, 2010, and entitled “ACCESS PERMISSIONS ENTITLEMENT REVIEW”, the disclosure of which is hereby incorporated by reference and priority of which is hereby claimed pursuant to 37 CFR 1.78(a) (1) and (2)(i).

Reference is also made to U.S. Provisional Patent Application Ser. No. 61/348,822, filed May 27, 2010 and entitled “IMPROVED TOOLS FOR DATA MANAGEMENT BY DATA OWNERS”, the disclosure of which is hereby incorporated by reference and priority of which is hereby claimed pursuant to 37 CFR 1.78(a) (4) and (5)(i).

Reference is also made to the following patents and patent applications, owned by assignee, the disclosures of which are hereby incorporated by reference:

U.S. Pat. Nos. 7,555,482 and 7,606,801; and

U.S. Published patent application Ser. Nos. 2007/0244899, 2008/0271157, 2009/0100058, 2009/0119298 and 2009/0265780.

### FIELD OF THE INVENTION

The present invention relates to data management systems and methodologies generally and more particularly to data access permission management systems and methodologies.

### BACKGROUND OF THE INVENTION

The following patent publications are believed to represent the current state of the art:

U.S. Pat. Nos.: 5,465,387; 5,899,991; 6,338,082; 6,393,468; 6,928,439; 7,031,984; 7,068,592; 7,403,925; 7,421,740; 7,555,482 and 7,606,801; and

U.S. Published patent application Ser. Nos.: 2003/0051026; 2004/0249847; 2005/0108206; 2005/0203881; 2005/0120054; 2005/0086529; 2006/0064313; 2006/0184530; 2006/0184459 and 2007/0203872.

### SUMMARY OF THE INVENTION

The present invention seeks to provide improved data access permission management systems and methodologies. There is thus provided in accordance with a preferred embodiment of the present invention a network object access permission management system useful with a computer network including at least one server and a multiplicity of clients, the system including an access permissions subsystem which governs access permissions of users to network objects in the computer network in real time and a future condition based permissions instruction subsystem providing instructions to the access permission subsystem to grant or revoke access permissions of the users to network objects in real time in response to future fulfillment of conditions which are established by an operator in advance.

In accordance with a preferred embodiment of the present invention, the future condition based permission instruction subsystem provides instructions to the access permission subsystem to grant or revoke access permissions of the users to the network objects at future times set in advance by the operator. Preferably, the future condition based permission instruction subsystem provides instructions to the access permission subsystem to grant or revoke access permissions of the users to the network objects in response to the occurrence of future events selected in advance by the operator. Additionally or alternatively, the future condition based permission instruction subsystem provides instructions to the access permission subsystem to grant and thereafter revoke access permissions of the users to the network objects at future times set in advance by the operator.

Preferably, the future condition based permission instruction subsystem provides instructions to the access permission subsystem to revoke and thereafter regrant pre-existing access permissions of the users to the network objects at future times set in advance by the operator. Additionally or alternatively, the future condition based permission instruction subsystem provides instructions to the access permission subsystem to grant to the users access permissions to the network objects for a limited duration set in advance by the operator.

Preferably, the future condition based permission instruction subsystem provides instructions to the access permission subsystem to grant or revoke access permissions of the users to the network objects based on changes in at least one characteristic of at least one user of the network object indicated in advance by the operator. Additionally or alternatively, the future condition based permission instruction subsystem provides instructions to the access permission subsystem to grant or revoke access permissions of the users to the network objects based on changes in at least one characteristic of the network object indicated in advance by the operator.

Preferably, the future condition based permission instruction subsystem provides instructions to the access permission subsystem to grant or revoke access permissions of the users to the network objects based on activity of at least one user related to the network object as indicated in advance by the operator. Additionally or alternatively, the future condition based permission instruction subsystem provides instructions to the access permission subsystem to grant or revoke access permissions of the users to the network objects based on changes in at least one classification of the network object indicated in advance by the operator.

There is also provided in accordance with another preferred embodiment of the present invention a network object access permission management method useful with a computer network including at least one server and a multiplicity of clients, the method including providing instructions to grant or revoke access permissions of users to network objects in real time in response to future fulfillment of conditions which are established by an operator in advance, and governing access permissions of the users to network objects in the computer network in real time in response to the instructions.

In accordance with a preferred embodiment of the present invention, the method includes providing instructions to grant or revoke access permissions of the users to the network objects at future times set in advance by the operator. Preferably, the method includes providing instructions to grant or revoke access permissions of the users to the network objects in response to the occurrence of future events selected in advance by the operator. Additionally or alternatively, the method includes providing instructions to grant and thereafter revoke access permissions of the users to the network objects at future times set in advance by the operator.

Preferably, the method includes providing instructions to revoke and thereafter regnant pre-existing access permissions of the users to the network objects at future times set in advance by the operator. Additionally or alternatively, the method includes providing instructions to grant to the users access permissions to the network objects for a limited duration set in advance by the operator.

Preferably, the method includes providing instructions to grant or revoke access permissions of the users to the network objects based on changes in at least one characteristic of at least one user of the network object indicated in advance by the operator. Additionally or alternatively, the method includes providing instructions to grant or revoke access permissions of the users to the network objects based on changes in at least one characteristic of the network object indicated in advance by the operator.

Preferably, the method includes providing instructions to grant or revoke access permissions of the users to the network objects based on activity of at least one user related to the network object as indicated in advance by the operator. Additionally or alternatively, the method includes providing instructions to grant or revoke access permissions of the users to the network objects based on changes in at least one classification of the network object indicated in advance by the operator.

### BRIEF DESCRIPTION OF THE DRAWINGS

The present invention will be understood and appreciated more fully from the following detailed description, taken in conjunction with the drawings in which:

FIGS. 1A, 1B, 1C, 1D, and 1E are simplified pictorial illustrations of operation of the data access permission management system of an embodiment of the present invention for revoking and thereafter regranting pre-existing access permissions of a user to network objects at future times set in advance by an operator;

FIGS. 2A, 2B, 2C, 2D, and 2E are simplified pictorial illustrations of operation of the data access permission management system of an embodiment of the present invention for revoking and thereafter regranting pre-existing access permissions of a user to network objects in response to a future event set in advance by an operator;

FIGS. 3A, 3B and 3C are simplified pictorial illustrations of operation of the data access permission management system of an embodiment of the present invention for changing access permissions of a user to network objects in response to a future event at a known date set in advance by an operator;

FIGS. 4A, 4B and 4C are simplified pictorial illustrations of operation of the data access permission management system of an embodiment of the present invention for changing access permissions of a user to network objects in response to a future event associated with a related user at a known date set in advance by an operator;

FIG. 5 is a simplified flowchart indicating steps in the operation of the data access permission management system of FIG. 1; and

FIG. 6 is another simplified flowchart indicating steps in the operation of the data access permission management system of FIG. 1.

### DETAILED DESCRIPTION OF PREFERRED EMBODIMENTS

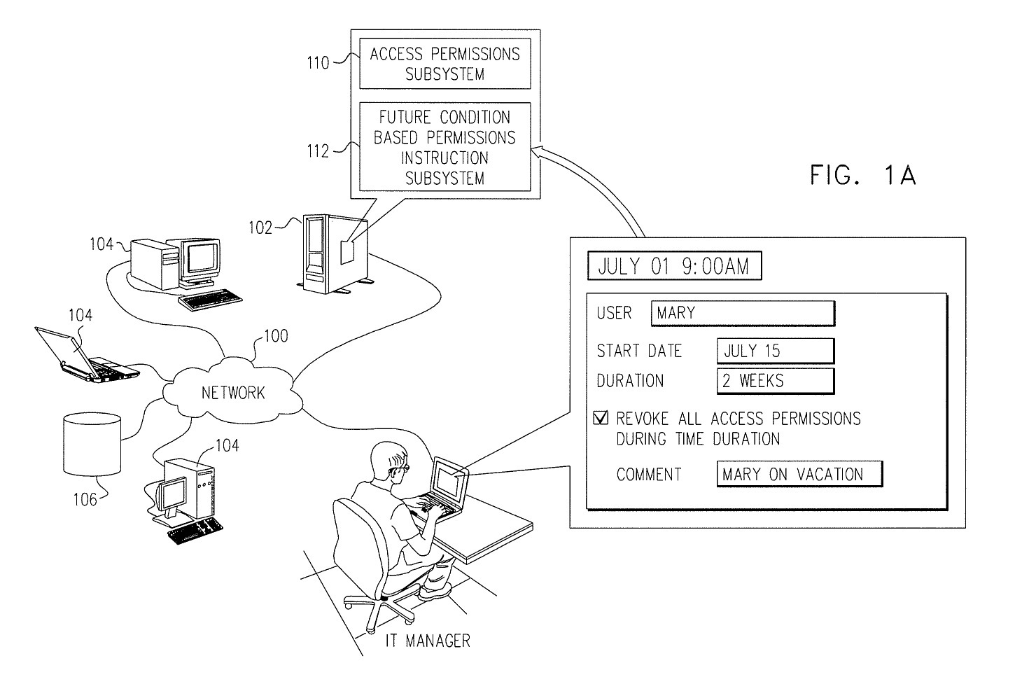

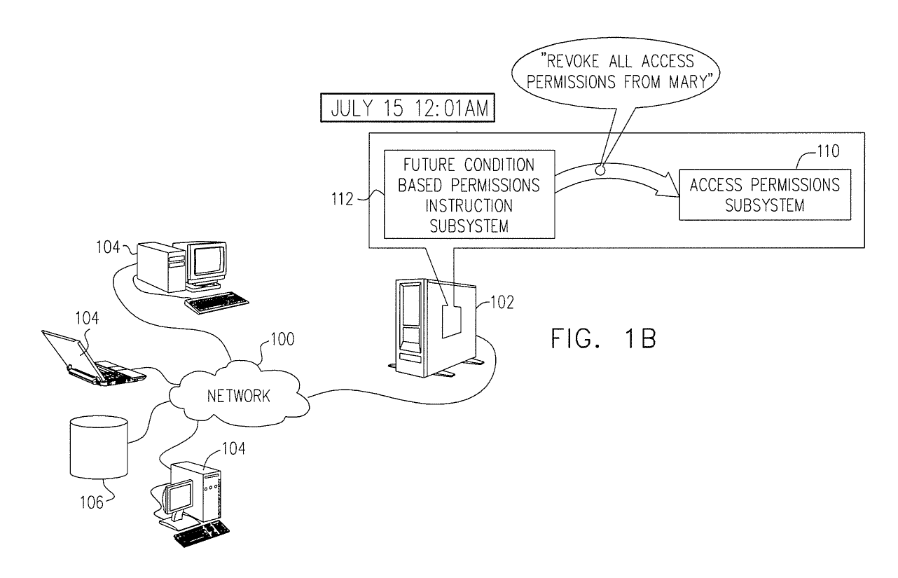

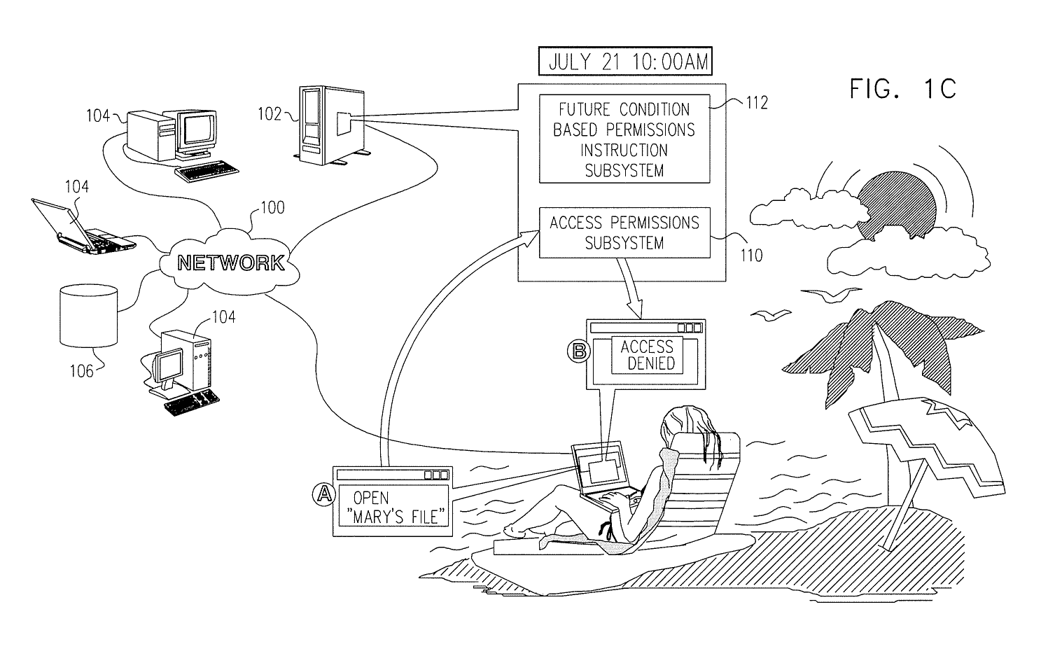

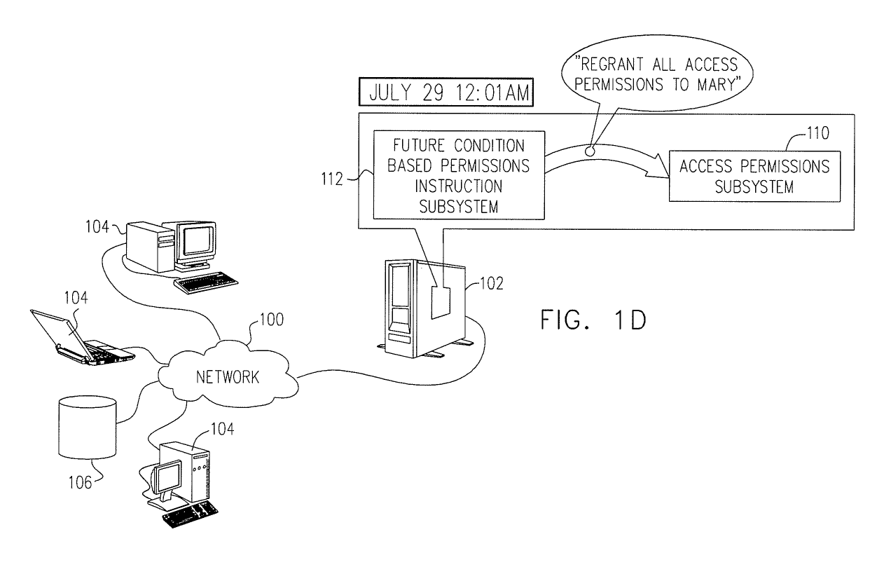

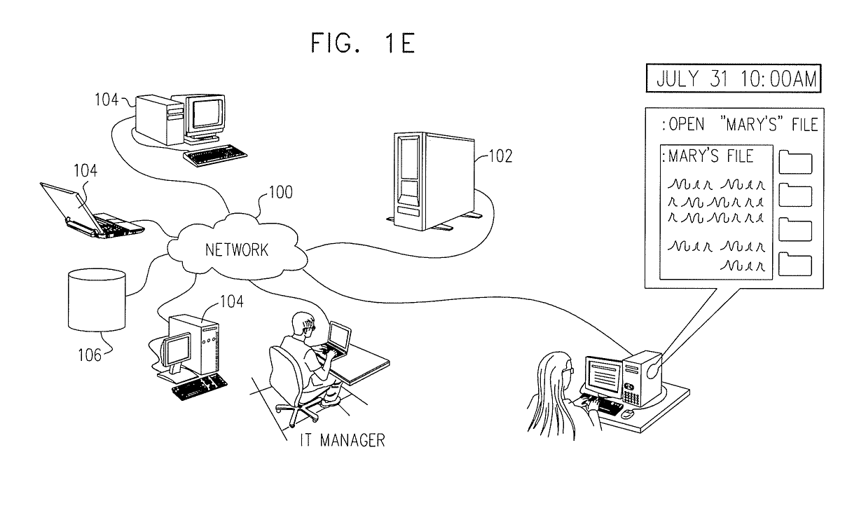

Reference is now made to FIGS. 1A, 1B, 1C, 1D and 1E, which are simplified pictorial illustrations of operation of the data access permission management system of an embodiment of the present invention for revoking and thereafter regranting pre-existing access permissions of a user to network objects at future times set in advance by an operator.

As seen generally in FIGS. 1A-1E, the network object access permission management system is useful with a computer network 100 including at least one server 102 and a multiplicity of clients 104. One or more storage elements 106 are also preferably provided. The system preferably resides on the server 102 and preferably includes:

an access permissions subsystem 110 which governs access permissions of users to network objects in the computer network 100 in real time; and

a future condition-based permissions instruction subsystem 112 providing instructions to the access permission subsystem 110 to grant or revoke access permissions of the users to network objects in real time in response to future fulfillment of conditions which are established by an operator in advance.

The term “network object” for the purposes of this application is defined to include user generated enterprise computer network resources on any commercially available computer operating system. Examples of network objects include structured and unstructured computer data resources such as files and folders, and user groups.

Access permissions of users to network objects may include for example, read or write permissions to a file, modification permissions to a folder (e.g. permissions to create or delete files), and modification permissions to a user group (e.g. permissions to add or remove a user from the group).

FIG. 1A shows a stage in typical operation of the data access permission management system, wherein an IT manager employs the future condition-based permission instruction subsystem 112 for revoking all access permissions for an employee about to go on vacation. The IT manager sets a future start date and a duration for the revocation, after which duration, the access permissions will be automatically restored.

FIG. 1B shows that at 12:01AM on Jul. 15, the future start date set by the IT manager, the future condition-based permission instruction subsystem 112 automatically provides instructions to the access permission subsystem to immediately revoke all access permissions to the employee.

As seen in FIG. 1C, for the duration of the employee's vacation, typically on Jul. 21, access is denied to the employee.

FIG. 1D illustrates that automatically upon expiration of the above duration, the future condition-based permission instruction subsystem automatically provides instructions to the access permission subsystem to immediately regrant all access permissions to the employee and FIG. 1E illustrates that thereafter, the employee employs the restored access permissions.

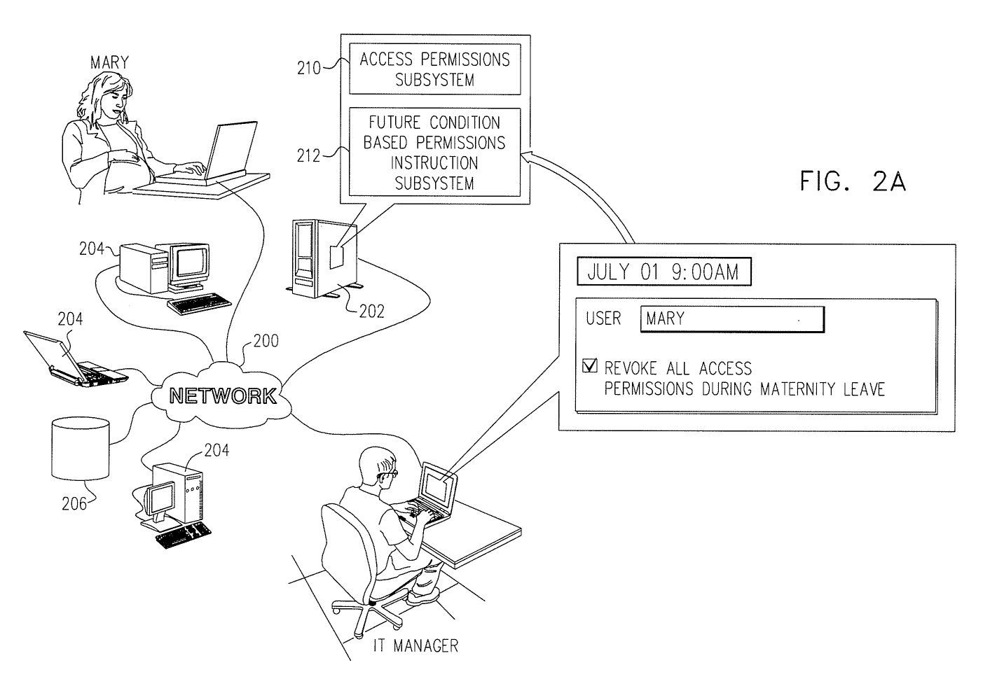

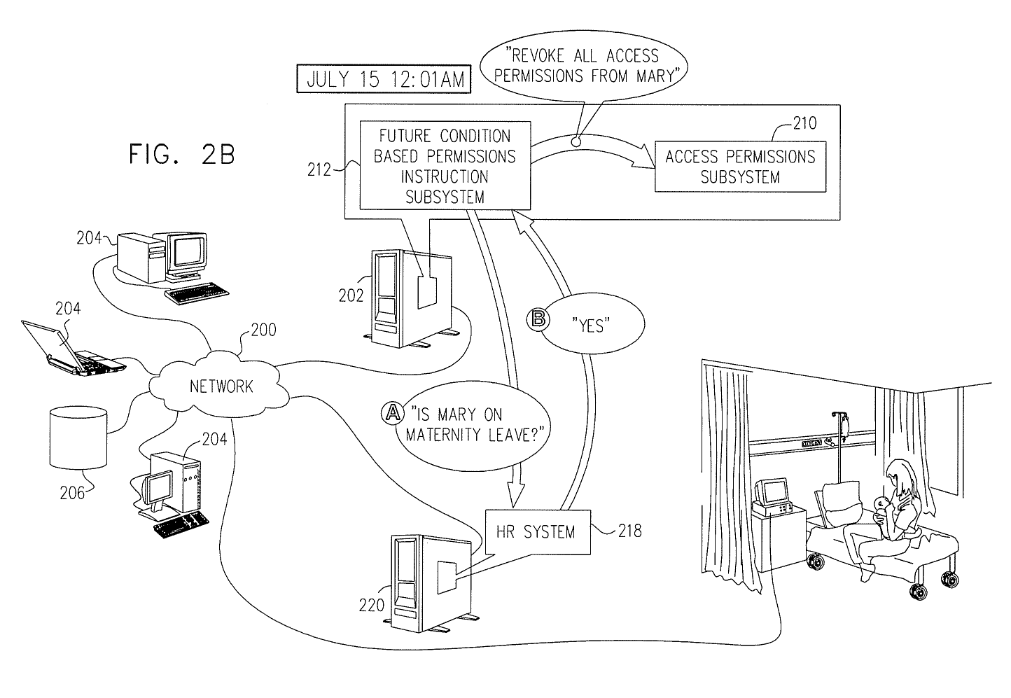

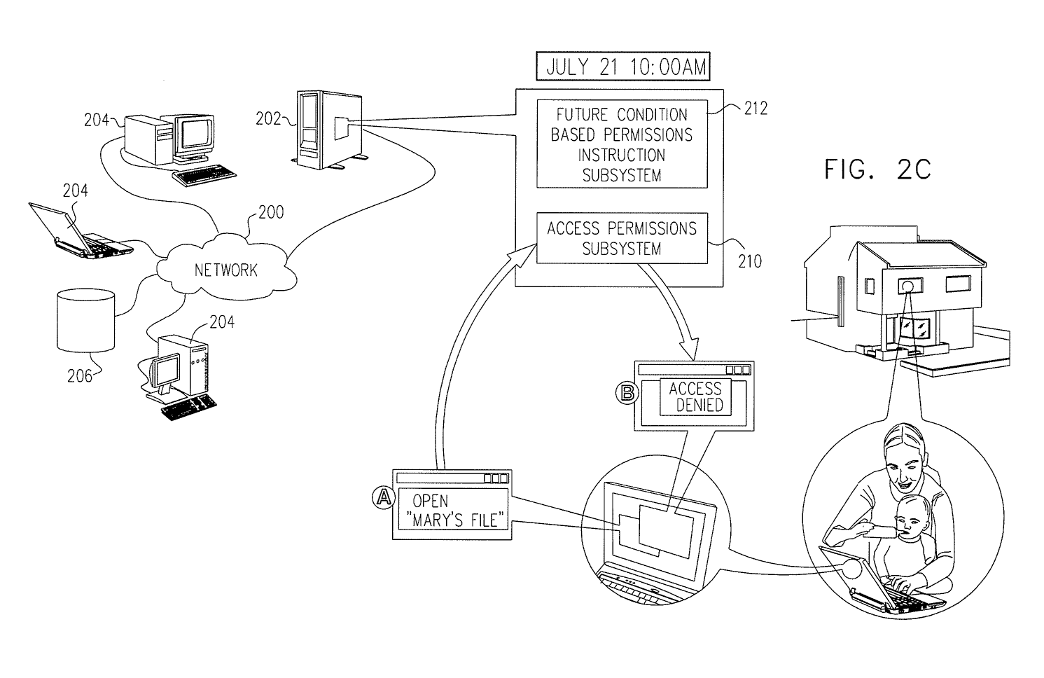

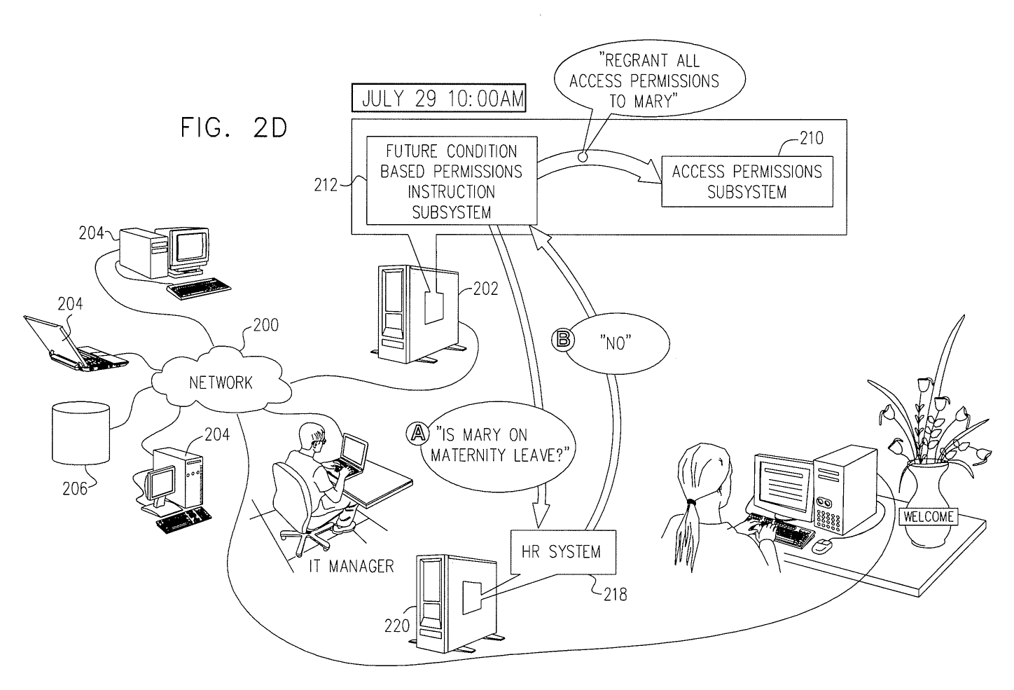

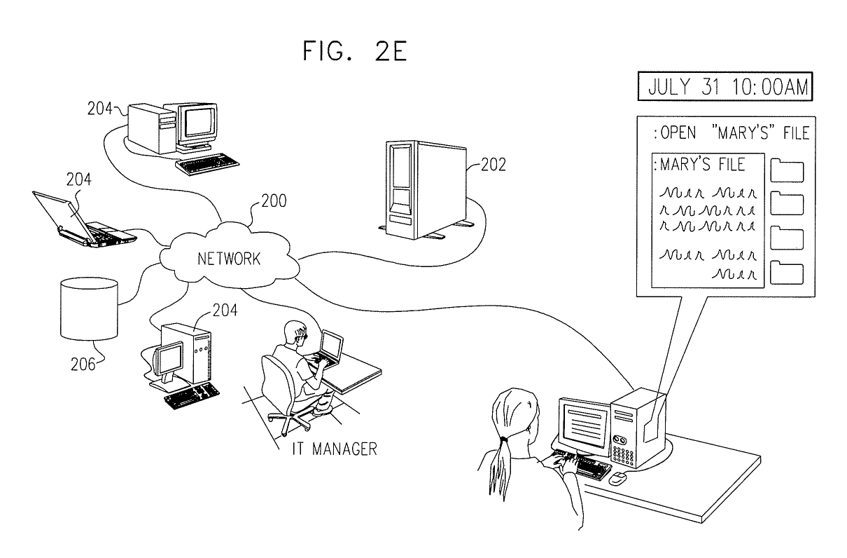

Reference is now made to FIGS. 2A, 2B, 2C, 2D, and 2E, which are simplified pictorial illustrations of operation of the data access permission management system of an embodiment of the present invention for revoking and thereafter regranting pre-existing access permissions of a user to network objects in response to a future event set in advance by an operator.

As seen generally in FIGS. 2A-2E, the network object access permission management system is useful with a computer network 200 including at least one server 202 and a multiplicity of clients 204. One or more storage elements 206 are also preferably provided. The system preferably resides on the server 202 and preferably includes:

an access permissions subsystem 210 which governs access permissions of users to network objects in the computer network 200 in real time; and

a future condition-based permissions instruction subsystem 212 providing instructions to the access permission subsystem 210 to grant or revoke access permissions of the users to network objects in real time in response to future fulfillment of conditions which are established by an operator in advance.

FIG. 2A shows a stage in typical operation of the data access permission management system, wherein an IT manager employs the future condition-based permission instruction subsystem 212 for revoking all access permissions for an employee who is about to give birth and go on maternity leave. The IT manager sets a condition for revoking access permissions, i.e. maternity leave, after which duration, the access permissions will be automatically restored.

FIG. 2B shows that at 12:01AM on Jul. 15, the future condition-based permission instruction subsystem 212 routinely queries a human resources system 218 residing on a server 220 connected to the network 200, whether the employee has given birth and is now on maternity leave. Upon discovering that the employee is now indeed on maternity leave, the future condition-based permission instruction subsystem 212 orders the access permissions subsystem 210 to revoke all access permissions from the employee.

As seen in FIG. 2C, for the duration of the employee's maternity leave, typically on Jul. 21, access is denied to the employee.

FIG. 2D illustrates that on Jul. 29 the future condition-based permission instruction subsystem 212 routinely queries the human resources system 218 and discovers that the employee is no longer on maternity leave. The future condition-based permission instruction subsystem 212 immediately orders the access permissions subsystem 210 to regrant all access permissions to the employee, and FIG. 2E illustrates that thereafter, the employee employs the restored access permissions.

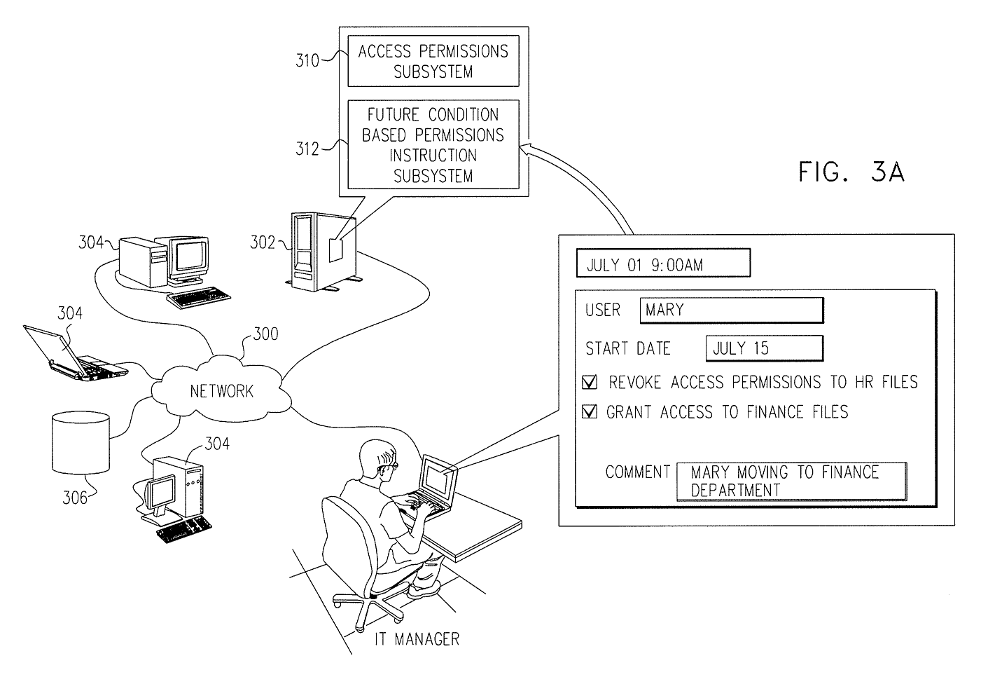

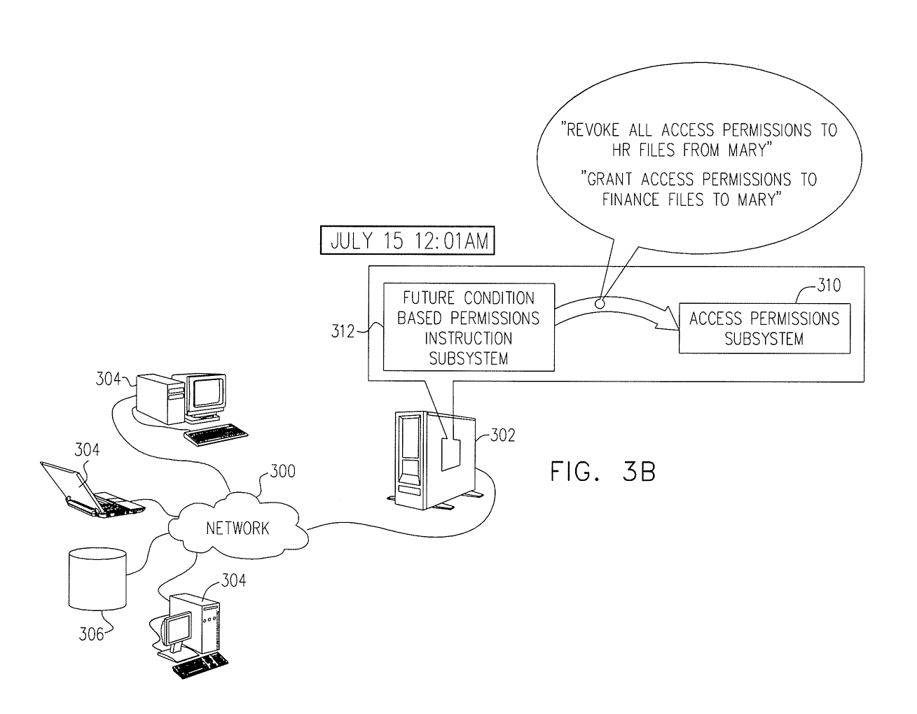

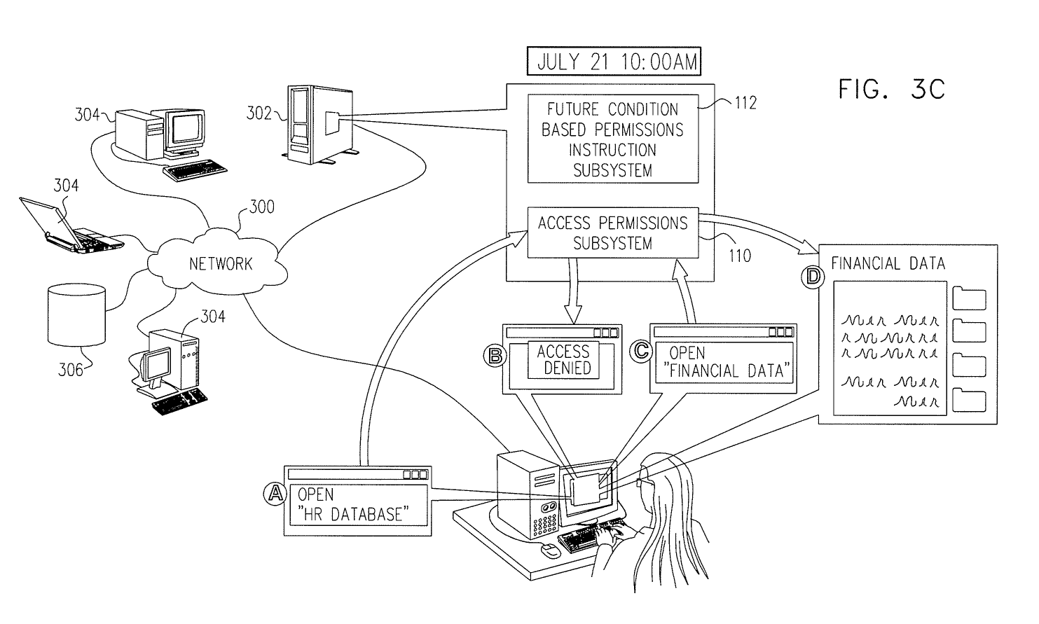

Reference is now made to FIGS. 3A, 3B and 3C, which are simplified pictorial illustrations of operation of the data access permission management system of an embodiment of the present invention for changing access permissions of a user to network objects in response to a future event at a known date set in advance by an operator

As seen generally in FIGS. 3A-3C, the network object access permission management system is useful with a computer network 300 including at least one server 302 and a multiplicity of clients 304. One or more storage elements 306 are also preferably provided. The system preferably resides on the server 302 and preferably includes:

an access permissions subsystem 310 which governs access permissions of users to network objects in the computer network 300 in real time; and

a future condition-based permissions instruction subsystem 312 providing instructions to the access permission subsystem 310 to grant or revoke access permissions of the users to network objects in real time in response to future fulfillment of conditions which are established by an operator in advance.

FIG. 3A shows a stage in typical operation of the data access permission management system, wherein an IT manager employs the future condition-based permission instruction subsystem 312 for revoking all access permissions for an employee to certain enterprise resources and for granting access permissions for the employee to other enterprise resources, due to the employee transferring to another department in the enterprise. The IT manager sets a future start date for the simultaneous revocation and granting of access permissions.

FIG. 3B shows that at 12:01AM on Jul. 15, the future start date set by the IT manager, the future condition-based permission instruction subsystem 312 automatically provides instructions to the access permission subsystem 310 to immediately revoke all existing access permissions to the employee, and to grant new, alternative, access permissions to the employee.

As seen in FIG. 3C, after transferring to another department in the enterprise, typically on Jul. 21, access to resources belonging to the previous department is denied to the employee, while access to resources belonging to the employee's new department is granted.

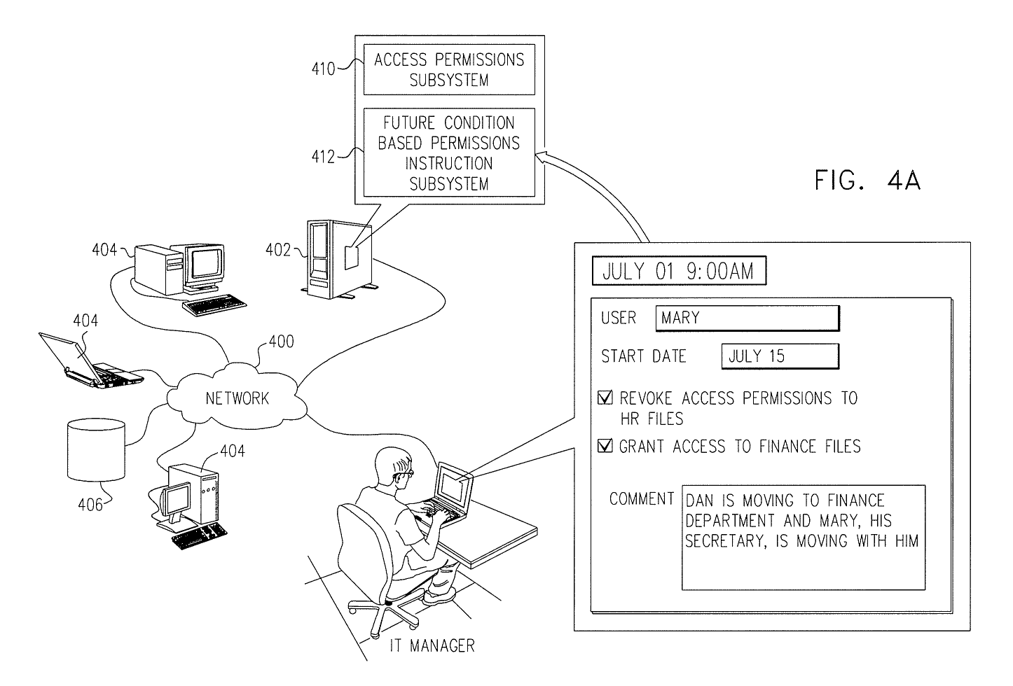

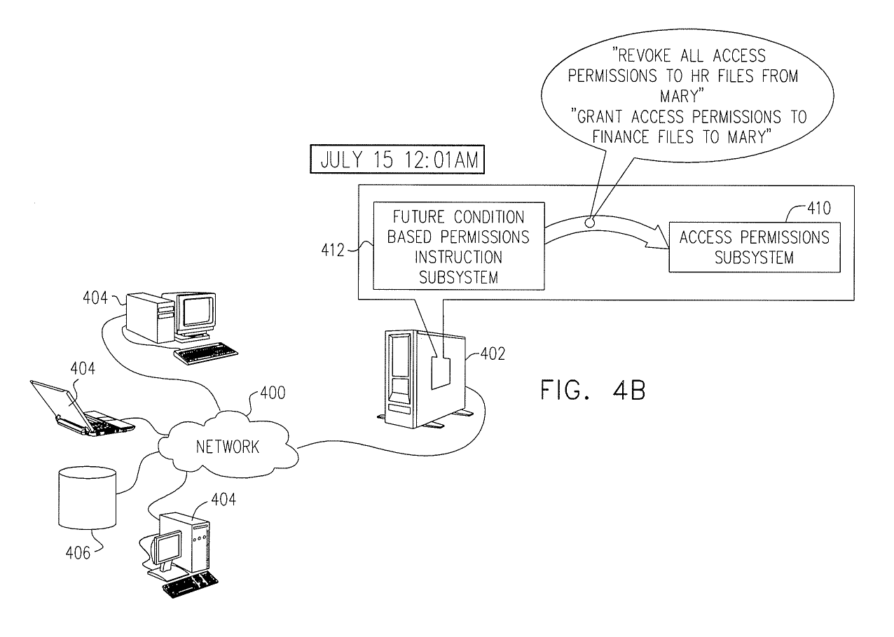

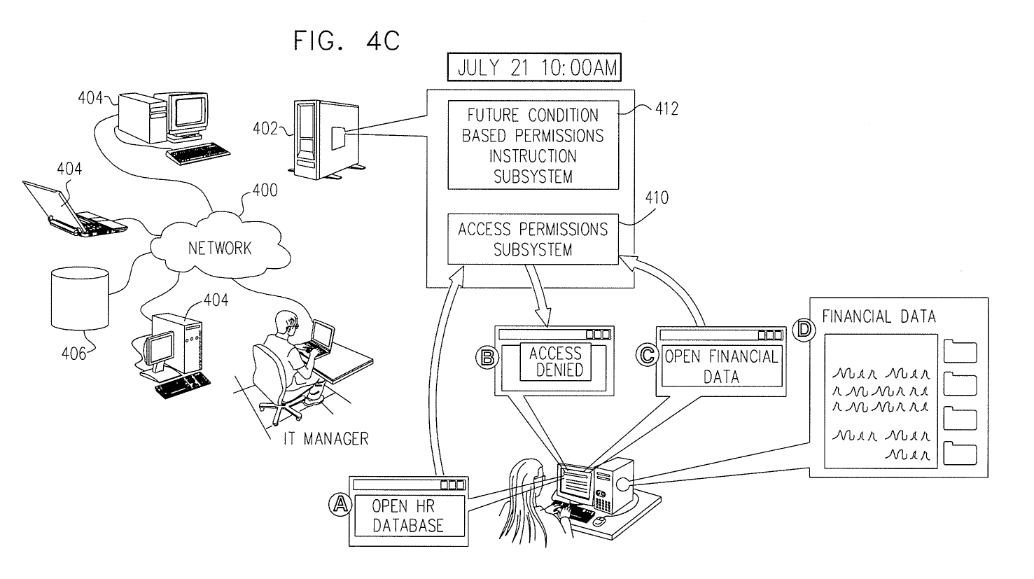

Reference is now made to FIGS. 4A, 4B and 4C, which are simplified pictorial illustrations of operation of the data access permission management system of an embodiment of the present invention for changing access permissions of a user to network objects in response to a future event associated with a related user at a known date set in advance by an operator.

As seen generally in FIGS. 4A-4C, the network object access permission management system is useful with a computer network 400 including at least one server 402 and a multiplicity of clients 404. One or more storage elements 406 are also preferably provided. The system preferably resides on the server 402 and preferably includes:

an access permissions subsystem 410 which governs access permissions of users to network objects in the computer network 400 in real time; and

a future condition-based permissions instruction subsystem 412 providing instructions to the access permission subsystem 410 to grant or revoke access permissions of the users to network objects in real time in response to future fulfillment of conditions which are established by an operator in advance.

FIG. 4A shows a stage in typical operation of the data access permission management system, wherein an IT manager employs the future condition-based permission instruction subsystem 412 for revoking all access permissions for an employee to certain enterprise resources and for granting access permissions for the employee to other enterprise resources, due to the employee transferring to another department in the enterprise as a result of the employee's manager transferring to another department in the enterprise. The IT manager sets a future start date for the simultaneous revocation and granting of access permissions.

FIG. 4B shows that at 12:01AM on Jul. 15, the future start date set by the IT manager, the future condition-based permission instruction subsystem 412 automatically provides instructions to the access permission subsystem 410 to immediately revoke all existing access permissions to the employee, and to grant new, alternative, access permissions to the employee.

As seen in FIG. 4C, after transferring to another department in the enterprise, typically on Jul. 21, access to resources belonging to the previous department is denied to the employee, while access to resources belonging to the employee's new department is granted.

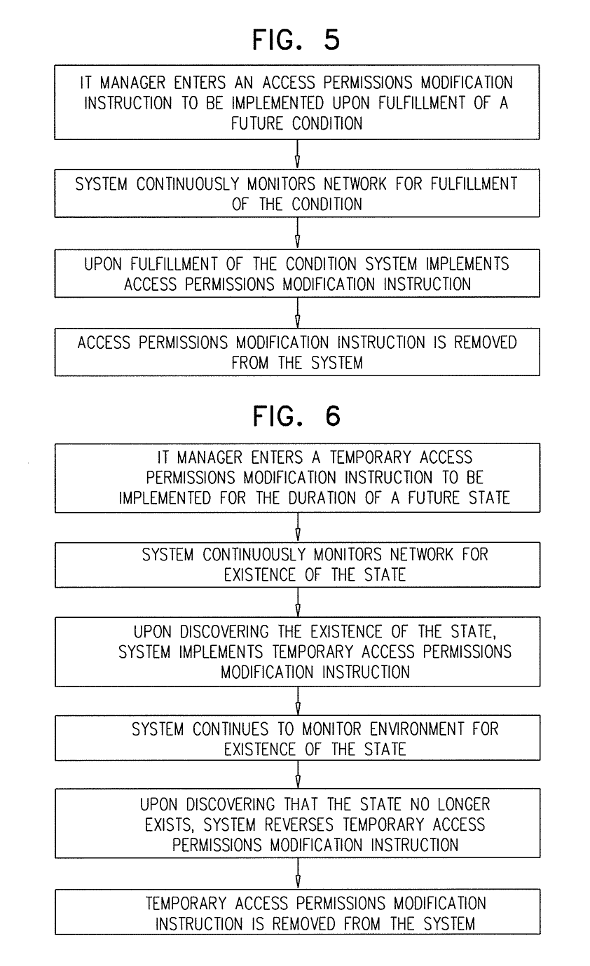

Reference is now made to FIG. 5, which is a simplified flowchart indicating steps in the operation of the data access permission management system of FIG. 1. As shown in FIG. 5, an IT manager utilizes the system by entering to the system an access permissions modification instruction to be implemented by the system upon fulfillment of a future condition. For example, the future condition may comprise the occurrence of a future date or an employee related event such as leave of absence of an employee, maternity leave, vacation leave, termination of employment of an employee and transfer of an employee to another department in the enterprise. The access permissions modification instruction may comprise granting or revoking access permissions of users to network objects.

The system continuously monitors relevant resources on the computer enterprise network for the fulfillment of the future condition. The resources may include, for example, human resources databases and IT security-related systems.

Upon discovery that the future condition has been fulfilled, the system implements the access permissions modification instruction, and removes the access permissions modification instruction and its related future condition from the system.

Reference is now made to FIG. 6, which is another simplified flowchart indicating steps in the operation of the data access permission management system of FIG. 1. As shown in FIG. 6, an IT manager utilizes the system by entering to the system a temporary access permissions modification instruction to be implemented by the system for the duration of a future state. For example, the future state may comprise the occurrence of a future date or range of dates, or an employee related state such as leave of absence of an employee, maternity leave, vacation leave and temporary transfer of an employee to another department in the enterprise. The temporary access permissions modification instruction may comprise temporarily granting or revoking access permissions of users to network objects.

The system continuously monitors relevant resources on the computer enterprise network for the existence of the state. The resources may include, for example, human resources databases and IT security-related systems.

Upon discovering the existence of the state, the system implements the temporary access permissions modification instruction. The system continues to monitor relevant resources on the computer enterprise network for the continued existence of the state.

Upon discovering that the state no longer exists, the system reverses the temporary access permissions modification instruction, and removes the temporary access permissions modification instruction and its related future state from the system.

It will be appreciated by persons skilled in the art that the present invention is not limited by what has been particularly shown and described hereinabove. Rather the scope of the present invention includes both combinations and subcombinations of the various features described hereinabove as well as modifications thereof which would occur to persons skilled in the art upon reading the foregoing description and which are not in the prior art.

1. A network object access permission management system useful with a computer network including at least one server and a multiplicity of clients, the system comprising:
an access permissions subsystem which governs access permissions of users to network objects in said computer network in real time; and
a future condition based permissions instruction subsystem providing instructions to said access permission subsystem to grant or revoke access permissions of said users to network objects in real time in response to future fulfillment of conditions which are established by an operator in advance.

2. A network object access permission management system according to claim 1 and wherein said future condition based permission instruction subsystem provides instructions to said access permission subsystem to grant or revoke access permissions of said users to said network objects at future times set in advance by said operator.

3. A network object access permission management system according to claim 1 and wherein said future condition based permission instruction subsystem provides instructions to said access permission subsystem to grant or revoke access permissions of said users to said network objects in response to the occurrence of future events selected in advance by said operator.

4. A network object access permission management system according to claim 1 and wherein said future condition based permission instruction subsystem provides instructions to said access permission subsystem to grant and thereafter revoke access permissions of said users to said network objects at future times set in advance by said operator.

5. A network object access permission management system according to claim 1 and wherein said future condition based permission instruction subsystem provides instructions to said access permission subsystem to revoke and thereafter regrant pre-existing access permissions of said users to said network objects at future times set in advance by said operator.

6. A network object access permission management system according to claim 1 and wherein said future condition based permission instruction subsystem provides instructions to said access permission subsystem to grant to said users access permissions to said network objects for a limited duration set in advance by said operator.

7. A network object access permission management system according to claim 1 and wherein said future condition based permission instruction subsystem provides instructions to said access permission subsystem to grant or revoke access permissions of said users to said network objects based on changes in at least one characteristic of at least one user of said network object indicated in advance by said operator.

8. A network object access permission management system according to claim 1 and wherein said future condition based permission instruction subsystem provides instructions to said access permission subsystem to grant or revoke access permissions of said users to said network objects based on changes in at least one characteristic of said network object indicated in advance by said operator.

9. A network object access permission management system according to claim 1 and wherein said future condition based permission instruction subsystem provides instructions to said access permission subsystem to grant or revoke access permissions of said users to said network objects based on activity of at least one user related to said network object as indicated in advance by said operator.

10. A network object access permission management system according to claim 1 and wherein said future condition based permission instruction subsystem provides instructions to said access permission subsystem to grant or revoke access permissions of said users to said network objects based on changes in at least one classification of said network object indicated in advance by said operator.

11. A network object access permission management method useful with a computer network including at least one server and a multiplicity of clients, the method comprising:
providing instructions to grant or revoke access permissions of users to network objects in real time in response to future fulfillment of conditions which are established by an operator in advance; and
governing access permissions of said users to network objects in said computer network in real time in response to said instructions.

12. A network object access permission management method according to claim 11 and wherein said method includes providing instructions to grant or revoke access permissions of said users to said network objects at future times set in advance by said operator.

13. A network object access permission management method according to claim 11 and wherein said method includes providing instructions to grant or revoke access permissions of said users to said network objects in response to the occurrence of future events selected in advance by said operator.

14. A network object access permission management method according to claim 11 and wherein said method includes providing instructions to grant and thereafter revoke access permissions of said users to said network objects at future times set in advance by said operator.

15. A network object access permission management method according to claim 11 and wherein said method includes providing instructions to revoke and thereafter regrant pre-existing access permissions of said users to said network objects at future times set in advance by said operator.

16. A network object access permission management method according to claim 11 and wherein said method includes providing instructions to grant to said users access permissions to said network objects for a limited duration set in advance by said operator.

17. A network object access permission management method according to claim 11 and wherein said method includes providing instructions to grant or revoke access permissions of said users to said network objects based on changes in at least one characteristic of at least one user of said network object indicated in advance by said operator.

18. A network object access permission management method according to claim 11 and wherein said method includes providing instructions to grant or revoke access permissions of said users to said network objects based on changes in at least one characteristic of said network object indicated in advance by said operator.

19. A network object access permission management method according to claim 11 and wherein said method includes providing instructions to grant or revoke access permissions of said users to said network objects based on activity of at least one user related to said network object as indicated in advance by said operator.

20. A network object access permission management method according to claim 11 and wherein said method includes providing instructions to grant or revoke access permissions of said users to said network objects based on changes in at least one classification of said network object indicated in advance by said operator.
